(19) United States
(12) Patent Application Publication
(10) Pub. No.: US 2002/0171612 A1
(43) Pub. Date: Nov. 21, 2002

(54) Call identifier display inversion

(76) Inventor: Dalton Swain Conselvan, Londrina (BR)

Correspondence Address: WARE FRESSOLA VAN DER SLUYS &, ADOLPHSON, LLP, BRADFORD GREEN BUILDING 5, 755 MAIN STREET, P O BOX 224, MONROE, CT, 06468, US

(21) Appl. No.: 10/050,016

(22) Filed: Jan. 15, 2002

(30) Foreign Application Priority Data
May 17, 2001 (BR) MU8100823-6

(51) Int. Cl. G09G 3/36

(52) U.S. Cl. 345/87

(57) ABSTRACT

A call identifier display inversion that improves identifiers of phone calls, with the possibility of inversion of the liquid crystal display. It consists of the combination of hardware LCD-display and software micro-controller that allows for the vertical inversion of the data presented on the display, once an external button or sensor is passed or activated. The device has a new matrix and implementation of new instructions and codes, which, once recorded in the circuit, result in the execution of reorganization instructions of the active dots, every time the controller receives a command by means of a button or any other electric signal.

The purpose of this patent is the upgrading of an electronic device for the identification of incoming phone calls, with the innovative aspect that this specific device presents the possibility of inversion of the liquid crystal display.

Phone call identifiers are common electronic devices nowadays; such devices employ a micro-controller (7), a phone line (6) multi-frequency signal decoder (5), a display (1), an energy source (2), data storage memory (11), etc.

The display has the function of showing the number of the telephone from which the phone call is originating, or the name of the caller, or also the name of the person to whom a call is being made. According to the external design of the identifier, the display can be seen in a wider or narrower angle.

Current phone call identifiers have been designed in such a way that there is only one position for the data display; either horizontally or vertically. Whatever the position, whoever is using the device must always position the LCD horizontally for better visualization.

This patent consists in the combination of hardware (LCD) and software (micro-controller) which enables the vertical inversion of the data presented in the display, once an external button or sensor is activated or pressed.

The LCD modules are interfaces in microprocessor systems, which utilize their own controlling device and may be programmed according to their matrix, receiving an operation routine via software. Such matrix is determined when the display in manufactured, during which dots gather forming either a letter, a number and/or icons such as a telephone (40), an envelope (41), etc. In the same way other dots may be eliminated to simplify the system and its programming.

### BRIEF DESCRIPTION OF THE DRAWINGS

FIG. 1: shows the operational diagram of the identifier of calls, where a button to activate the display inversion has been added (9), and is connected to the micro-controller. The diagram also identifies the keyboard of the call identifier (8), the module receiving multi-frequency signals (4), the module of energy source (3), and the processor (10).

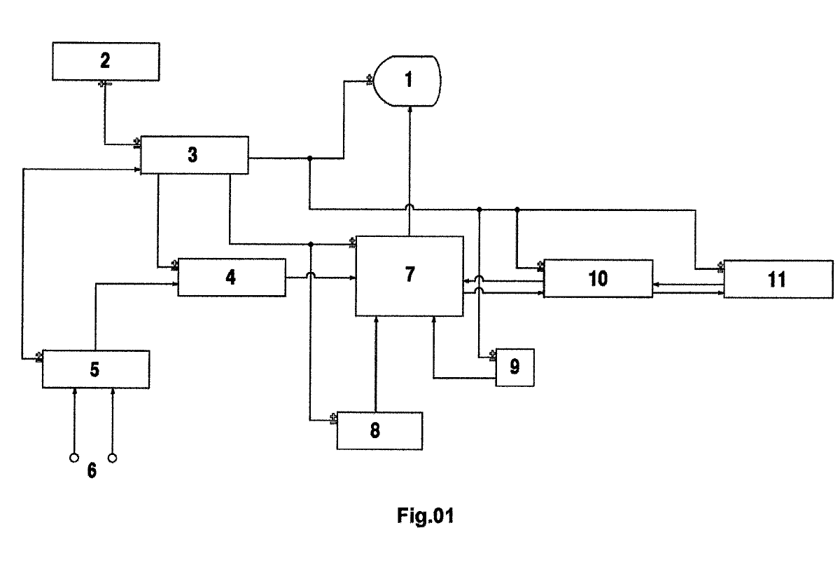

FIG. 2: illustrates the identifier casing, wich can be displayed horizontally or vertically. In the first option the display is in the original position (21). Whenever the person using the device wishes to place the device in the horizontal position, all such person has to do is press the inversion button for a few seconds and the controller will alter the instructions on the display screen.

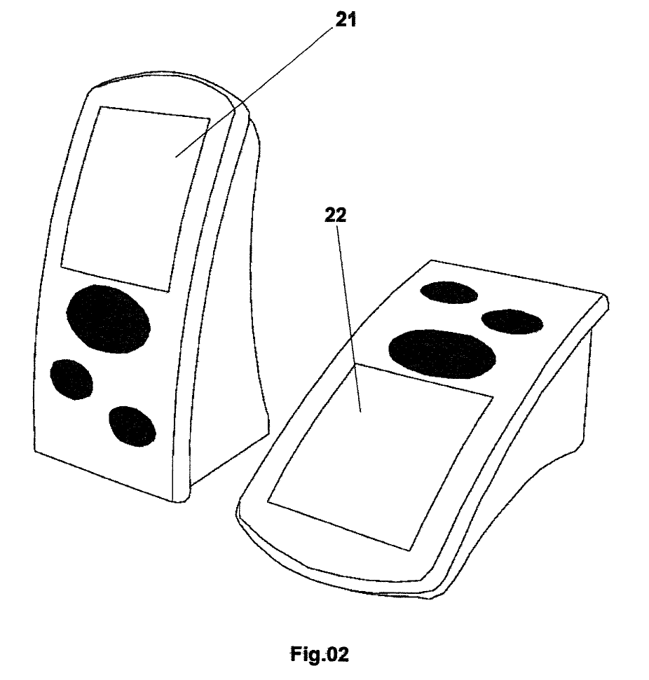

FIG. 3: shows the matrix of the display, where one can find the lines for names (31), numbers (32), minutes (33), and logo (34). In the first position, the display may be switched to “stand-by” (35), or in the process of identifying an incoming call. In the second position the display is inverted on stand-by (36) and also when turned on (38).

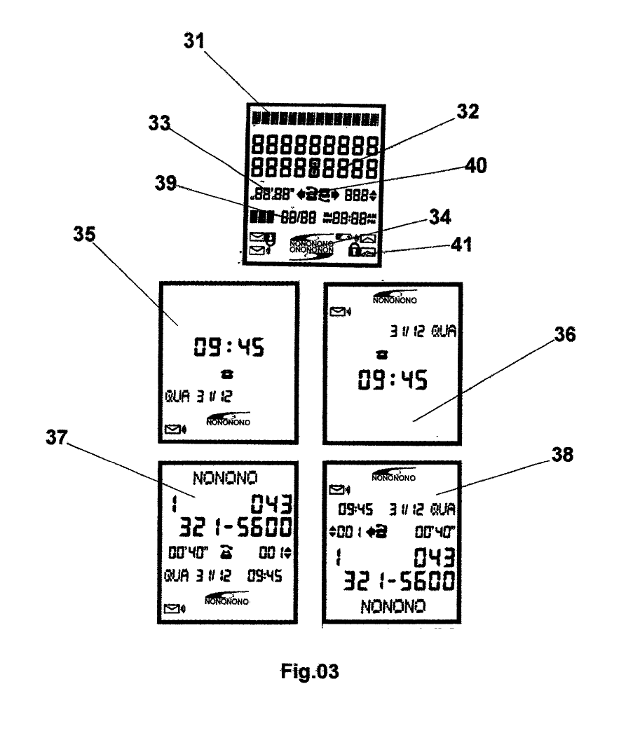

According to the illustrations, the display model is based upon a new matrix and implementation of new instructions and codes, witch, once recorded in its circuits, follow the reorganization instructions of the active dots every time the controller receives a command by means of a button, sensor, or any other form of electric signal.

The applied matrix consists of pre-determined fields witch will form the characters of letter or number. The inversion of the display is not symmetrical, that is, the fields will also be presented in the new lay-out, but without affecting the reading of the data. In other words, the field which names (31), for instance, will be seen in the upper part of the display in one position, and in the lower part in the other; the same happening witty the number (32), minutes (33) and date (39). Icons such as manufacturer's logo (34), telephone (40) and envelope (41), have double matrix, that is, they are inverted side by side, so that the corresponding version is activated according to the position of the display. Since they consist of gathered or grouped dots, each icon is activated with only one code.

Therefore, this model presents a number of advantages over current models, besides the innovative aspect, thus deserving the legal protection being requested.

What is claimed is:

1- A call identifier display inversion; comprising a combination of hardware LCD and software micro-controller, that enable the vertical inversion of data presented on the screen, upon pressing an external button or sensor;
an external button for the activation of the display inverter connected to the micro-controller;
a display with a differentiated matrix for the formation of characters in the fields for numbers, minutes and dates;
a circuit that obeys instructions to reorganize the active dots every time the controller receives a command via activation button, sensor or any other form electrical signal;
the following icons or figures: manufacturer's logo, telephone and envelope and also having double matrix, so that they are inverted side by side.
